(19) United States
(12) Patent Application Publication
(10) Pub. No.: US 2014/0324990 A1
(43) Pub. Date: Oct. 30, 2014

(54) METHOD AND DEVICE FOR TRANSMITTING AND RECEIVING MULTIPLE FILES

(71) Applicants: Xiao Long Zhang, Shenzhen (CN); Shushen Lu, Shenzhen (CN); Yi Duan, Shenzhen (CN); Wei Li, Shenzhen (CN)

(72) Inventors: Xiao Long Zhang, Shenzhen (CN); Shushen Lu, Shenzhen (CN); Yi Duan, Shenzhen (CN); Wei Li, Shenzhen (CN)

(21) Appl. No.: 13/993,625

(22) PCT Filed: Apr. 27, 2013
(86) PCT No.: PCT/CN13/74908

§ 371 Date: Jun. 12, 2013

(51) Int. Cl. H04L 12/58

(52) U.S. Cl. CPC H04L 51/08
USPC 709/206

(57) ABSTRACT

Examples of the present disclosure provide a method, an Instant Messaging (IM) client for transmitting multiple files, and an IM client for receiving multiple files. The method includes: receiving by an IM client one final request for transmitting N files to an IM user, wherein N is a positive integer, which is larger than or equal to 2; obtaining by the IM client the N files; adding, by the IM client, the N files to a transmitting process; and transmitting by the IM client the obtained N files, until all of the N files are transmitted. By employing the technical solution of the present disclosure, transmission of multiple files, such as, pictures, audios, videos, documents may be more convenient, and user experience may be improved.

### FIELD

The present disclosure relates to Instant Messaging (IM) techniques, and more particularly, to a method and a device for transmitting and receiving multiple files.

### BACKGROUND

Instant Messaging (IM) is a form of communication over the Internet that offers quick transmission of messages from sender to receiver. It may address point-to-point communications as well as multicast communications from one sender to many receivers. More advanced instant messaging allows enhanced modes of communication, such as live voice or video calling, video chat and inclusion of hyperlink to media.

In recent years, IM tools have been accepted by the majority of Internet users and become essential network tools. It should be noted that, network IM tools are widely used not only in usual entertainment, but also in users' work. The IM tools are frequently used by the users to communicate with their friends, colleagues and students in life and work. Therefore, users may put forward higher requirements in ease of use, stability, security and other aspects of IM tools (such as IM software).

With continuous development of IM technologies, IM may include various specific implementation modes, which not only include a real-time communication mode, but also include an asynchronous and non-real-time communication mode, such as WeChat. The WeChat is growing steadily as a new product and new application with information transmission mechanism of IM tools. The WeChat supports to rapidly transmit voice short message, video, picture and characters from a WeChat user to another WeChat, and supports a group chat.

### SUMMARY

Various examples of the present disclosure provide a method and a device for transmitting and receiving multiple files in Instant Messaging (IM).

According to one example of the present disclosure, a method for transmitting multiple files in IM includes: receiving by an IM client one final request for transmitting N files to an IM user, wherein N is a positive integer, which is larger than or equal to 2; adding, by the IM client, the N files to a transmitting process; obtaining by the IM client the N files; and transmitting by the IM client the obtained N files, until all of the N files are transmitted.

According to another example of the present disclosure, an IM client for transmitting multiple files includes an interface, a processor and a memory, in which the interface is configured to receive one final request for transmitting N files to an IM user, wherein N is a positive integer, which is larger than or equal to 2; the processor is configured to obtain the N files from the memory, add the N files to a transmitting process, and transmit the obtained N files, until all of the N files are transmitted.

According to another example of the present disclosure, an IM client for receiving multiple files includes an interface, a processor and a memory, in which the interface is configured to receive the N files at a time destined for an IM user, wherein N is a positive integer, which is larger than or equal to 2, and is further configured to receive a viewing request; the memory is configured to save the N files each time; and the processor is configured to provide the N files, when the interface receives the viewing request.

The method and device provided by various examples of the present disclosure beneficially enables transmission of multiple files to become more convenient. Subsequently, efficiency of transmission about multiple files may be improved, and user experience may be enhanced.

The features and advantages described in the disclosure are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the disclosed subject matter.

### BRIEF DESCRIPTION OF THE DRAWINGS

Features of the present disclosure are illustrated by way of example and not limited in the following figure(s), in which like numerals indicate like elements, in which:

FIG. 1 is a flowchart illustrating a method for transmitting multiple files at a time, in accordance with an example of the present disclosure.

FIG. 2 is a flowchart illustrating a method for transmitting multiple files at a time, in accordance with an example of the present disclosure.

FIG. 3 is a flowchart illustrating another method for transmitting multiple files at a time, in accordance with an example of the present disclosure.

FIG. 4 is a flowchart illustrating still another method for transmitting multiple files at a time, in accordance with an example of the present disclosure.

FIG. 5 is a block diagram illustrating structure of an Instant Messaging (IM) client for transmitting multiple files at a time, in accordance with an example of the present disclosure.

FIG. 6 is a block diagram illustrating structure of an IM client for receiving multiple files at a time, in accordance with an example of the present disclosure.

### DETAILED DESCRIPTION

Hereinafter, the present disclosure will be described in further detail with reference to the accompanying drawings and examples to make the technical solution and merits therein clearer.

For simplicity and illustrative purposes, the present disclosure is described by referring mainly to an example thereof. In the following description, numerous specific details are set forth in order to provide a thorough understanding of the present disclosure. It will be readily apparent however, that the present disclosure may be practiced without limitation to these specific details. In other instances, some methods and structures have not been described in detail so as not to unnecessarily obscure the present disclosure. As used herein, the term “includes” means includes but not limited to, the term “including” means including but not limited to. The term “based on” means based at least in part on. In addition, the terms “a” and “an” are intended to denote at least one of a particular element.

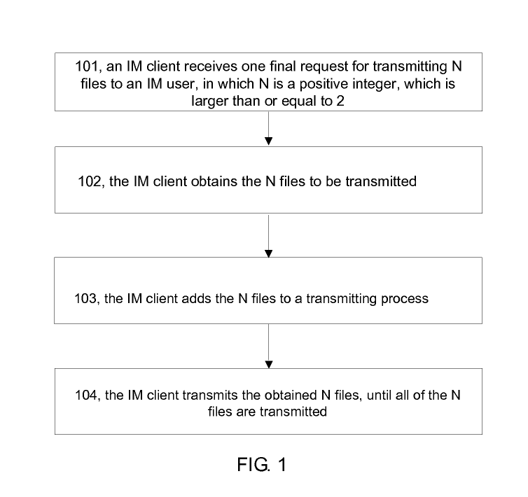

FIG. 1 is a flowchart illustrating a method for transmitting multiple files at a time, in accordance with an example of the present disclosure. As shown in FIG. 1, the method may include the following blocks.

Block 101, an IM client receives one final request for transmitting N files to an IM user, in which N is a positive integer, which is larger than or equal to 2.

Specifically speaking, in a first case, before the IM client receives the final request for transmitting N files to the IM user, that is, before the IM user finally determines whether to transmit all of the N files, the IM client may firstly receive one initial request for transmitting N files to the IM user, and the IM client may provide the N files to be previewed by the IM user.

When the IM user finally determines to transmit the N files, which are previewed by the IM user, the IM user may transmit the final request for transmitting the N files destined for the IM client.

Specifically speaking, in a second case, before the IM client receives one final request for transmitting N files to an IM user, the IM client may firstly receive one initial request from a first IM user for transmitting M files to a second IM user, that is, the first IM user may click on the N files on a file selection interface provided by the IM client for the first time, and the IM client may provide the M files to be previewed by the IM user, in which M is a positive integer, which is larger than or equal to (N+1).

After the IM user has previewed the M files, the IM user may determine to remove P files, and then the IM user may transmit an intermediate request for removing P files from the M files to be transmitted, in which P is larger than or equal to 1, and (M−P)=N. In practical applications, the IM user may determine to remove at least one file during the preview process.

And then, the IM client may provide N files to be previewed by the IM user. When the IM user finally determines to transmit the N files, the IM user may transmit the final request for transmitting the N files to the IM client.

Specifically speaking, in a third case, as mentioned in foregoing second case, before the IM client receives one final request for transmitting N files to an IM user, the IM client may firstly receive one initial request from a first IM user for transmitting M files to a second IM user, that is, the first IM user may firstly click on the M files on a file selection file provided by the IM client, and then the IM client may receive a first intermediate request for removing P files from the M files, after the first IM user has previewed the M files. Subsequently, the first IM user may determine to add S files to be transmitted together, and then, the IM user may transmit a second intermediate request for adding S files to be transmitted to the second IM user, in which S is a positive integer.

In the following, the IM client may provide the (M−P+S) files to be previewed by the first IM user, in which (M−P+S)=N, when the first IM user finally determines to transmit (M−P+S) files, the first IM user may transmit the final request for transmitting the N files destined for the second IM user to the IM client.

Block 102, the IM client obtains the N files. Specifically speaking, when the final request for transmitting the N files to the IM user carries an identifier of each file, the IM client may obtain a corresponding file from a database of the IM client, according to the identifier carried in the final request.

Block 103, the IM client adds the N files to a transmitting process.

Specifically speaking, the IM client may firstly receive an adding sequence of the N files selected by the IM user, and add the N files to the transmitting process, according to the received adding sequence of the N files.

Block 104, the IM client transmits the obtained N files. Specifically speaking, there may be various implementation modes for the IM client to transmit the N files, according to the transmitting process, which will be described in detail in the following examples.

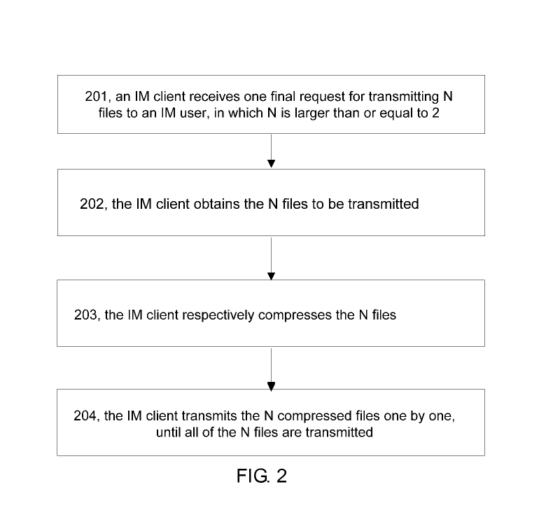

FIG. 2 is a flowchart illustrating a method for transmitting multiple files at a time destined for an IM user, in accordance with an example of the present disclosure. As shown in FIG. 2, the method may include the following blocks.

Block 201, an IM client receives one final request for transmitting N files to an IM user, in which N is a positive integer, which is larger than or equal to 2. Specifically speaking, the final request may carry an identifier of each file to be transmitted

Block 202, the IM client obtains the N files to be transmitted. Specifically speaking, the IM client may obtain a corresponding file from a database of the IM client, according to the identifier carried in the final request, which is received in block 201, and then buffer the N files.

The IM client may receive an adding sequence of the N files selected by the IM user, and add the N files to a transmitting process of the IM client, according to the received adding sequence of the N files.

Block 203, the IM client respectively compresses the N files, which are obtained from the database of the IM client and buffered by the IM client. Suppose the N files are pictures, after compressing the N pictures one by one, size of each compressed picture may be smaller than that of the original picture, which doesn't affect viewing. Subsequently, the IM client may put the N compressed files into a queue with a First In First Out (FIFO) mechanism, waiting to be transmitted.

It should be noted that, the IM client may firstly add the N files to the transmitting process of the IM client, and then respectively compress the N files to be transmitted. Alternatively, the IM client may also firstly respectively compress the N files, and then add the N compressed files to the transmitting process.

Block 204, the IM client transmits the N compressed files one by one to an IM server, until all of the N compressed files are transmitted. Subsequently, the IM server may forward the N compressed files to a receiving IM client to be viewed. As mentioned in block 203, when the N files are pictures which are compressed, the receiving IM client may view the compressed pictures without de-compression.

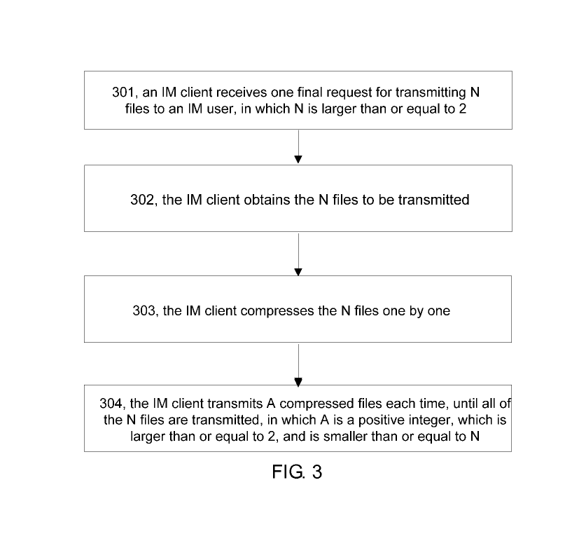

FIG. 3 is a flowchart illustrating another method for transmitting multiple files at a time destined for an IM user, in accordance with an example of the present disclosure. As shown in FIG. 3, the method may include the following blocks.

Blocks 301 to 303 are similar to foregoing blocks 201 to 203, which are not repeated here.

Block 304, the IM client transmits A compressed files each time, until all of the N files are transmitted, in which A is a positive integer, which is larger than or equal to 2, and is smaller than or equal to N. When the value of A is equal to N, it means that the IM client may transmit the N compressed files at a time.

In the example illustrated with FIG. 3, suppose N=7, A=2, the IM client may compress the 7 files one by one, and respectively transmit 2 compressed files for three times. The IM client may transmit the last file separately.

Subsequently, an IM server may receive the 7 compressed files, and forward to a receiving IM client, to enable the receiving IM client to view the 7 compressed files.

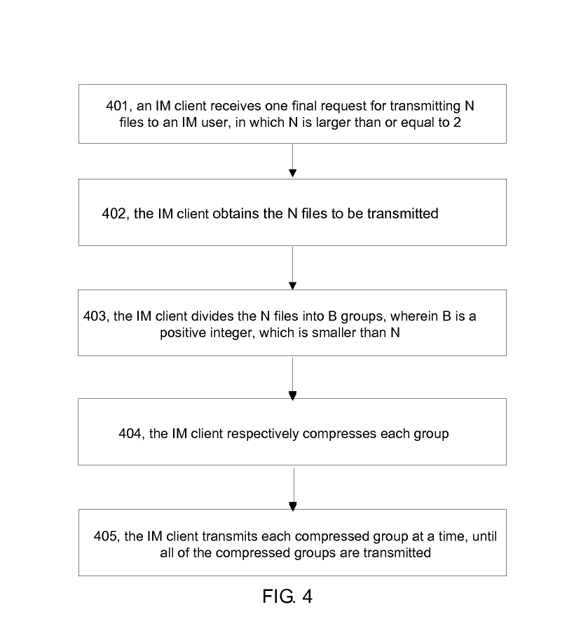

FIG. 4 is a flowchart illustrating still another method for transmitting multiple files at a time destined for an IM user, in accordance with an example of the present disclosure. As shown in FIG. 4, the method may include the following blocks.

Blocks 401 to 402 are similar to foregoing blocks 201 to 202, which are not repeated here.

Block 403, the IM client divides the N files into B groups, in which B is a positive integer, which is smaller than N. In the example, suppose N=6, B=3, the IM client may divide the 6 files into 3 group. There are two files in each group. Specifically speaking, the N files may include at least one of a picture, an audio, a video and a document. When the N files belong to the same type, the IM client may divide the N files into the B groups, based on file number in each group. When the N files belong to different types, suppose picture and document, the IM client may divide the N files into the B groups, based on file type.

Block 404, the IM client may respectively compress each group, and then add each group to a transmitting process, according to sequence of each group being compressed. Suppose N=6, B=3, and then 3 compressed groups may be obtained.

Block 405, the IM client transmits each compressed group at a time, until all of the compressed groups are transmitted. That is, the 6 files in the three groups may be transmitted by the IM client for 3 times. Subsequently, the 6 files in the three groups may be received by an IM server, to be forwarded to a receiving IM client. And then, the IM client may view the 6 files.

In the foregoing examples illustrated with FIGS. 1˜4, the file may include at least one of a picture, an audio, a video and a document. Generally speaking, users may transmit files of the same type at a time. That is, the N files may belong to the same type in most cases. When the N files are pictures, in practical applications, size of a compressed picture may be smaller than that of an original picture. Correspondingly, quality of the compressed picture may be reduced, which usually doesn't affect viewing by a receiving IM client. Subsequently, the receiving IM client may directly view the compressed files received without executing de-compressing operations. Generally speaking, when the N files belong to the audio, the video, or the document, after being compressed and transmitted to a receiving IM client, the IM client may view the compressed files after executing the de-compression.

It should be noted that, the first, second and third cases in the example illustrated with FIG. 1 are also applicable to examples illustrated with FIGS. 2˜4. In all of the foregoing examples, the IM client may be a WeChat client, and the IM server may be a WeChat server.

By employing foregoing methods for transmitting multiple files, such as pictures, audios, videos and documents, transmission of multiple files may become more convenient, transmission efficiency may be improved and user experience may also be enhanced.

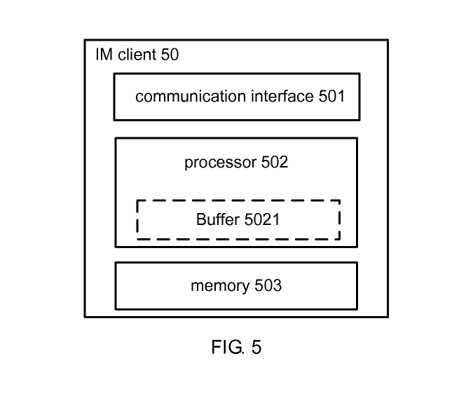

FIG. 5 is a block diagram illustrating structure of an IM client for transmitting multiple files at a time to an IM user, in accordance with an example of the present disclosure.

As shown in FIG. 5, the IM client 50 may include a communication interface 501, a processor 502 and a memory 503. The communication interface 501 is configured to receive one final request for transmitting N files to an IM user, and N is a positive integer, which is larger than or equal to 2.

The processor 502 may obtain the N files from the memory 503, add the N files to a transmitting process, and transmit the N files, until the N files are transmitted. Specifically speaking, the final request received by the communication interface 501 may carry an identifier of each of the N files, and then the processor 502 may obtain a file corresponding to the identifier from the memory 503. The processor 502 is further configured to receive an adding sequence of the N files selected by the IM user, and add the N files to the transmitting process, according to the received adding sequence of the N files.

Alternatively, the processor 502 may also include a buffer 5021. After the processor 501 obtaining the N files, the processor 502 may put the N files into a queue one by one with a First In First Out (FIFO) mechanism, and buffer the N files. The N files in the queue wait to be transmitted. After a file is correctly transmitted, the file buffered in the queue may be removed from the queue.

Referring to FIG. 5, in a first scene, after obtaining the N files, the processor 502 may respectively compress the N files, and transmit the compressed N files one by one, until all of the N files are transmitted.

Referring to FIG. 5, in a second scene, after obtaining the N files, the processor 502 may respectively transmit the N files one by one without compressing the N files, until all of the N files are transmitted.

Referring to FIG. 5, in a third scene, after obtaining the N files, the processor 502 may respectively compress the N files, and then, the processor 502 may transmit A compressed files each time, until all of the N files are transmitted, in which A is a positive integer, which is smaller than or equal to N.

Suppose N=6, A=2, in the third scene, the processor 502 may respectively compress the 6 files, and transmit 2 files each time, until all of the 6 files are transmitted.

Referring to FIG. 5, in a fourth scene, after obtaining the N files, the processor 502 may divide the N files into B groups, in which B is a positive integer, which is smaller than N, and compress each group. Subsequently, the processor 502 may transmit each compressed group at a time, until all of the B compressed groups are transmitted.

In the fourth scene, suppose N=8, B=4, the processor 502 may divide the 8 files into 4 groups, and then compress each group, which includes 2 files. Subsequently, the processor 502 may transmit a compressed group at a time, until all of the 8 files in the 4 groups are transmitted.

It should be noted that, the N files may belong to, or not belong to the same type. The N files may include at least one of a picture, an audio, a video and a document. In the foregoing fourth scene, when the processor 502 divides the 8 files into 4 groups, two files in each group may belong to the same type.

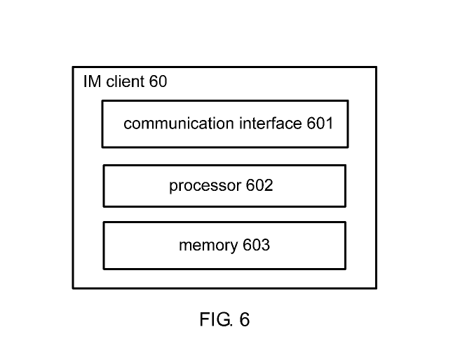

FIG. 6 is a block diagram illustrating structure of an IM client for receiving multiple files at a time, in accordance with an example of the present disclosure. As shown in FIG. 6, the IM client 60 may include a communication interface 601, a processor 602 and a memory 603.

The communication interface 601 is configured to receive the N files at a time destined for an IM user, in which N is a positive integer, which is larger than or equal to 2, and is further configured to receive a viewing request. The memory 603 is configured to save the received N files each time. The processor 602 is configured to provide the N files, when the communication interface 601 receives the viewing request.

When the communication interface 601 receives A compressed files at a time destined for the IM user from a transmitting IM client, which are received and forwarded by an IM server, in which A is a positive integer, which is larger than or equal to 2, the memory 603 is configured to save the A compressed files each time; and the processor 602 is further configured to analyze the A compressed files, and provide the analyzed A compressed files, when the communication interface 601 receives the viewing request.

Specifically speaking, when the A files are pictures, the processor 602 may provide the A compressed files to be viewed without de-compression, when the communication interface 601 receives a viewing request. Since a compressed file with smaller size is also readable. When the A compressed files are audios, videos or documents, the processor 602 may firstly automatically de-compress the A files, and then provide the A files for an IM user to be viewed, when the communication interface 601 receives a viewing request.

When the communication interface 601 receives a compressed group at a time destined for the IM user from a transmitting IM client, which are received and forwarded by an IM server, the memory 603 is configured to save files carried the compressed group each time, and the processor 602 is configured to analyze the files in each compressed group, and provide the files in the compressed group for an IM user, when the communication interface 601 receives a viewing request.

By employing foregoing method and device for transmitting multiple files at a time destined for an IM user, such as pictures, audios, videos and documents, transmission of multiple files each time may become more convenient, transmission efficiency may be improved and user experience may also be enhanced.

The figures are only illustrations of an example, wherein the modules or procedure shown in the figures are not necessarily essential for implementing the present disclosure. The modules in the aforesaid examples can be combined into one module or further divided into a plurality of sub-modules.

What is claimed is:

1. A method for transmitting multiple files in Instant Messaging (IM), comprising:
receiving, by an IM client, one final request for transmitting N files to an IM user, wherein N is a positive integer, which is larger than or equal to 2;
obtaining, by the IM client, the N files;
adding, by the IM client, the N files to a transmitting process; and
transmitting, by the IM client, the obtained N files, until all of the N files are transmitted.

2. The method according to claim 1, further comprising:
after obtaining by the IM client the N files, respectively compressing, by the IM client, the obtained N files, and
wherein transmitting by the IM client the obtained N files comprises:
transmitting, by the IM client, the compressed N files one by one, until all of the N files are transmitted.

3. The method according to claim 1, further comprising:
after obtaining by the IM client the N files, respectively compressing, by the IM client, the obtained N files, and
wherein transmitting by the IM client the obtained N files comprises:
transmitting, by the IM client, A compressed files each time, until all of the N files are transmitted, wherein A is a positive integer, which is smaller than or equal to N.

4. The method according to claim 1, further comprising:
after obtaining by the IM client the N files, dividing, by the IM client, the N files into B groups, wherein B is a positive integer, which is smaller than N, and compressing each group;
wherein transmitting by the IM client the obtained N files comprises:
transmitting, by the IM client, each compressed group at a time, until all of the B compressed groups are transmitted.

5. The method according to claim 4, wherein the file comprises at least one of a picture, an audio, a video and a document, and files in each group belong to the same type.

6. The method according to claim 3, further comprising:
receiving and viewing, by a receiving IM client, the A compressed files each time, which are received and forwarded by an IM server.

7. The method according to claim 4, further comprising:
receiving and viewing, by a receiving IM client, files in each compressed group at a time, which are received and forwarded by an IM server.

8. The method according to claim 1, wherein adding by the IM client the N files to the transmitting process comprises:
receiving, by the IM client, an adding sequence of the N files selected by an IM user; and
adding, by the IM client, the N files to the transmitting process, according to the received adding sequence of the N files.

9. The method according to claim 1, further comprising:
before receiving by the IM client the final request for transmitting the N files to the IM user,
receiving, by the IM client, one initial request for transmitting N files to the IM user; and
providing, by the IM client, the N files to be previewed.

10. The method according to claim 1, further comprising:
before receiving by the IM client the final request for transmitting the N files to the IM user, receiving, by the IM client, one initial request for transmitting M files to the IM user, wherein M is a positive integer, which is larger than or equal to (N+1);
providing, by the IM client, the M files to be previewed; and
receiving, by the IM client, an intermediate request for removing P file from the M files to be transmitted, wherein P is larger than or equal to 1, and (M−P)=N.

11. The method according to claim 1, further comprising:
before receiving by the IM client the final request for transmitting the N files to the IM user,
receiving, by the IM client, one initial request for transmitting Q files to the IM user, wherein Q is a positive integer;
providing, by the IM client, the Q files to be previewed;
receiving, by the IM client, a first intermediate request for removing R files from the Q files to be transmitted, wherein R is a positive integer, and Q is larger than or equal to R;
receiving, by the IM client, a second intermediate request for adding S files to be transmitted, wherein S is a positive integer, which is larger than or equal to 1; and
providing, by the IM client, (Q−R+S) files to be previewed, wherein (Q−R+S)=N.

12. An Instant Messaging (IM) client for transmitting multiple files, wherein the IM client comprises an interface, a processor and a memory,
the interface is configured to receive one final request for transmitting N files to an IM user, wherein N is a positive integer, which is larger than or equal to 2;
the processor is configured to obtain the N files from the memory, add the N files to a transmitting process, and transmit the obtained N files, until all of the N files are transmitted.

13. The IM client according to claim 12, wherein the processor is further configured to respectively compress the obtained N files, and transmit the compressed N files one by one, until all of the N files are transmitted.

14. The IM client according to claim 12, wherein the processor is further configured to respectively compress the obtained N files, and transmit A compressed files each time, until all of the N files are transmitted, wherein A is a positive integer, which is smaller than or equal to N.

15. The IM client according to claim 12, wherein the processor is further configured to divide the N files into B groups, wherein B is a positive integer, which is smaller than N, compress each group, and transmit each compressed group at a time, until all of the B compressed groups are transmitted.

16. The IM client according to claim 15, wherein the file comprises at least one of a picture, an audio, a video and a document, and files in each group belong to the same type.

17. The IM client according to claim 12, wherein the processor is further configured to receive an adding sequence of the N files selected by an IM user, and add the N files to the transmitting process, according to the received adding sequence of the N files.

18. The IM client according to claim 13, wherein the interface is further configured to receive one initial request for transmitting N files to the IM user; and
the processor is further configured to provide the N files to be previewed.

19. The IM client according to claim 13, wherein the interface is further configured to receive one initial request for transmitting M files to the IM user, receive an intermediate request for removing P files from the M files to be transmitted, wherein M and P are positive integers, and (M−P)=N; and
the processor is further configured to provide the M files to be previewed; wherein the M files are saved in the memory.

20. The IM client according to claim 13, wherein the interface is further configured to receive one initial request for transmitting Q files to the IM user, receive a first intermediate request for removing R files from the Q files to be transmitted to the IM user, and receive a second intermediate request for adding S files to be transmitted to the IM user, wherein Q, R and S are positive integers, and Q is larger than or equal to R; and
the processor is further configured to provide the Q files to be previewed, and provide (Q−R+S) files to be previewed, wherein (Q−R+S)=N.

21. An Instant Messaging (IM) client for receiving multiple files, wherein the IM client comprises an interface, a processor and a memory,
the interface is configured to receive the N files at a time destined for an IM user, wherein N is a positive integer, which is larger than or equal to 2, and is further configured to receive a viewing request;
the memory is configured to save the N files each time; and
the processor is configured to provide the N files, when the interface receives the viewing request.

22. The IM client according to claim 21, wherein when the interface receives A compressed files at a time destined for the IM user from a transmitting IM client, which are received and forwarded by an IM server, wherein A is a positive integer, which is larger than or equal to 2,
the memory is configured to save the A compressed files each time; and
the processor is further configured to analyze the A compressed files, and provide the analyzed A compressed files, when the interface receives the viewing request.

23. The IM client according to claim 21, wherein when the interface receives a compressed group at a time destined for the IM user from a transmitting IM client, which are received and forwarded by an IM server,
the memory is configured to save files in the compressed group each time, and
the processor is configured to analyze the files in the compressed group, and provide the files in the compressed group, when the interface receives a viewing request.
